(19) United States
(12) Patent Application Publication
(10) Pub. No.: US 2011/0289840 A1
(43) Pub. Date: Dec. 1, 2011

(54) CARRIER FOR GROWING MACROALGAE IN A WATER VOLUME, AND AN ARRANGEMENT FOR SUSPENDING SUCH A CARRIER

(75) Inventor: Paal Bakken, Cascais (PT)

(73) Assignee: SEAWEED ENERGY SOLUTIONS AS, Trondheim (NO)

(21) Appl. No.: 13/142,045

(22) PCT Filed: Dec. 23, 2009
(86) PCT No.: PCT/NO2009/000444

§ 371 Date: Aug. 17, 2011

(30) Foreign Application Priority Data
Dec. 30, 2008 (NO) 20085410

(51) Int. Cl. A01G 33/00; A01G 31/02

(52) U.S. Cl. 47/59 R

(57) ABSTRACT

Carrier for growing macroalgae, with an element provided for the growth of seeds deposited thereon, and having elements for suspension in a water volume. The carrier is a sheet provided with apertures allowing flow of water from one side to the other, the surface of the sheet having a structure which will retain spores and seeds. The invention is also directed to an arrangement for suspending such a carrier with a device connected to at least one part of an edge of the carrier. The device may be a platform submersed in the sea, to which the carrier is attached.

The invention relates to a carrier for macroalgaeculture as described in the introductory part of claim 1 and an arrangement for suspending such carriers.

### BACKGROUND

There are two categories of algae; macroalgae and microalgae. This inventions relates to the farming of macroalgae commonly known as seaweed. Farming of seaweeds has a long tradition in Asia. Where seaweed is cultivated for production of food ingredients, feedstock, carrageenan, agar, alginates and medical applications. Recently there is a growing interest to use seaweed for energy, such as biogas, bioethanol, electricity etc., pharmaceuticals, petrochemical replacements, and production of bioplastics.

Currently, seaweeds are seeded on ropes which are attached manually to larger ropes in the sea. The ropes are anchored with multiple points and there are various ways of deployment in the sea, vertically as well as horizontally.

There is a need for a more industrial, automated seeding, farming and harvesting system for seaweeds, particularly for being competitive as a energy crop.

From Japanese patent application 2006325563 it is known to suspend multiple sheet like carriers hanging in ropes from a series of floating bodies. This arrangement suffers from various drawbacks, including the need for manual work for mounting and harvesting of the carriers, and the sensitivity of the carriers in a water mass with currents.

From Japanese patent 3083529 it is known to provide a holding tool for growing seaweed, comprising frames with a net, to which seed ropes are attached. The ropes have spores adhered thereto and a resin coated fertilizer being provided in a container. This system demands manual work in sowing the spores and harvesting the algae, which will not allow large scale growing for energy purposes.

From Chinese patent 1132275 it is known to prepare a base for growing seaweed by using a polypropylene web as a raw material. From Japanese patent 9000096 it is known to prepare an algae culturing net from polyvinyl. From Japanese patent 11262337 it is known a net for culturing seaweed which improves the yield, by having the net prepared without knots. Neither of these nets have been suitable for large scale, mechanically operated growing of seaweed.

It is also known from Japanese patent application to suspend a net of considerable length with inclined ropes to anchors.

Thus there is no carrier proposed which is available for both mechanically handling and mechanically harvesting of the grown seaweed. Furthermore, there is no carrier proposed that ensures no entanglement of marine mammals, such as whales.

Furthermore, seaweed farms are currently located in protected or semi-protected areas of the ocean since they are not constructed to withstand the extreme forces in the open ocean environment

### OBJECTS OF THE INVENTION

The main object of the invention is to make the whole seaweed cultivation process, including seeding, farming, maintenance, transport and harvesting, more efficient, including providing a structure suitable for automated farming, allowing the use of machines for applying seeds and for harvesting.

A further object is to provide a carrier which can stand flow and movement of water in an open sea area, allowing seaweed culture in larger areas of the sea.

It is a further object to provide a carrier which prohibits mammal entanglement, which is a problem with rope and net based seaweed farming systems.

Further objects will be disclosed in the following description of the invention.

### THE INVENTION

A carrier according to the invention is described in claim 1. Thus it comprises a sheet of a flexible material which has a pattern of apertures allowing water to pass from one side of the carrier to the other. The carrier can comprise a web of ribbons, but consists preferably of a sheet with apertures in a pattern. The carrier is designed to grow large wild brown seaweeds or similar macroalgae.

Claim 10 is describing an arrangement for suspending carriers according to the invention.

Further features of the invention are described in the claims 2-9 and in claims 11-15.

The sheets may be made of a solid or porous material, or may be laminated from two or more sub-sheets or assembled from fibres. The material may be organic or any other material providing flexibility, which preferably is biodegradeable. The carrier sheet may be manufactured for one-time use, to be recycled mechanically at harvesting, preferably with mechanical means, or being reusable several times.

The carrier sheet may have a negative or positive buoyancy, the buoyancy being adjustable with additional means, such as ropes or other elements with positive or negative buoyancy.

The carrier may have a rectangular or similar form, including various leaf forms. It may also be in the form of a long blanket, attached to a mooring means at one or both ends.

The carrier may be designed for attachment at one or more points or sides to other carriers and/or to an attachment means, like a rope. Alternatively, the carriers may have a single point attachment at one corner.

Generally, the carrier according to the invention can be moored in one of following ways:
Single point mooring to the sea bottom
Single point mooring to horizontal lines
Single point mooring to vertical lines
Multiple point mooring
Edgewise mooring to a line
Edgewise mooring to a similar carrier

The carrier may also be arranged in groups of two or more in various arrangements, as will be shown in the Examples.

The material of the carrier sheets may be translucent or opaque, depending on the way of utilizing. When used in several stacks in a water volume, a translucent material will be preferable, to gain more light for the photosynthesis.

The top layer or both the top and bottom layer may have a hoarse surface for carrying spores or seed to be placed on the carrier, e.g. by spraying or immersing into a suspension.

The carrier according to the invention may be arranged for use in an unidirectional flow of water. It may also be suspended or moored to stand multidirectional flows.

The apertures central to this invention may be provided by punching or as a part of the process generating the sheet material of the carrier. The apertures may be longitudinal slots, or other kinds of openings arranged in a pattern suitable for the area of use and the sea area in which it is used.

The carrier sheet is preferably homogeneous, but may have reinforcement, e.g. In the form of an integrated net. It may also have a rim, e.g. along all sides, which is enlarged to stand the use of attachment means or which may be provided with a rope suitable for attachment to suspension elements.

When providing a carrier in the form of a long carpet, the buoyancy properties may vary along the length to provide an undulated position in the water. This may make the carrier withstand higher waves and allow a higher growth area.

An important consideration in the design of the carrier is the challenges created by the size and by the need for mechanical handling. Mechanical handling poses restrictions as to the width of a sheet being manufactures, e.g. in a factory site located close to the sea, for expelling into the sea. The carrier sheets thus should be suitable for linking together multiple longitudinal webs. The elements of this linking should be suitable for cutting or disconnecting with mechanical means at harvesting.

The connection between carrier elements in the operative mode should allow both for heavy waves and for whales and other mammals posing a risk to prior art seaweed farms.

The carrier according to the invention may be suspended like a carpet in a single horizontal layer or with multiple horizontal layers in a stack, e.g. 2-3 layers, with a multiple point suspension.

Alternatively single carriers or groups of carriers may be arranged with a single point mooring. This is particularly suitable when the seaweed culture is placed in an area with changing directions of flow of the water and/or in areas with storms, posing a risk to large structures of carriers with suspension on all sides.

The carriers according to the invention may be manufactured of a material which incorporates a growth substance, normally in the form of a fertilizer for the particular seaweeds. Alternatively or additionally, growth substances may be added as a deposit on the carrier sheet.

The growth substance can be various organic or part organic waste, e.g. residues from handling of municipal waste water, or from various organic materials. Included is also the recycling of the carrier according to the invention, when this carrier is of organic material.

The carrier according to the invention may be dragged into the sea, but may also be delivered in rolls, for seagoing transport to a site remote from the manufacturing site.

The features of the invention are described in the claims, which should be interpreted to cover the details of the description.

The invention can be used for growing seaweed for various purposes. It is however mainly intended for high volume growing, for purposes such as producing bioethanol, biogas and various co- and by-products.

### EXAMPLES

Embodiments of the invention is described in the following, with reference to the drawings, in which

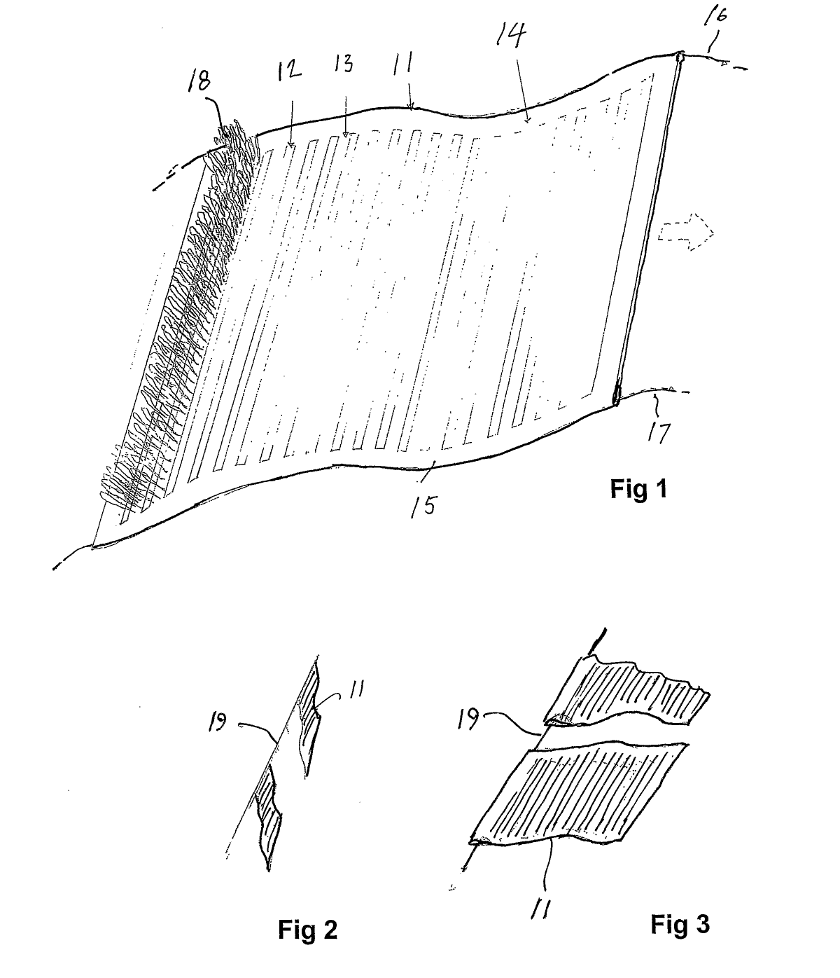

FIG. 1 is showing a perspective view of an embodiment of a carrier according to the invention,

FIGS. 2 and 3 are showing a perspective view of two embodiments for suspending a rectangular carrier according to the invention in a water volume,

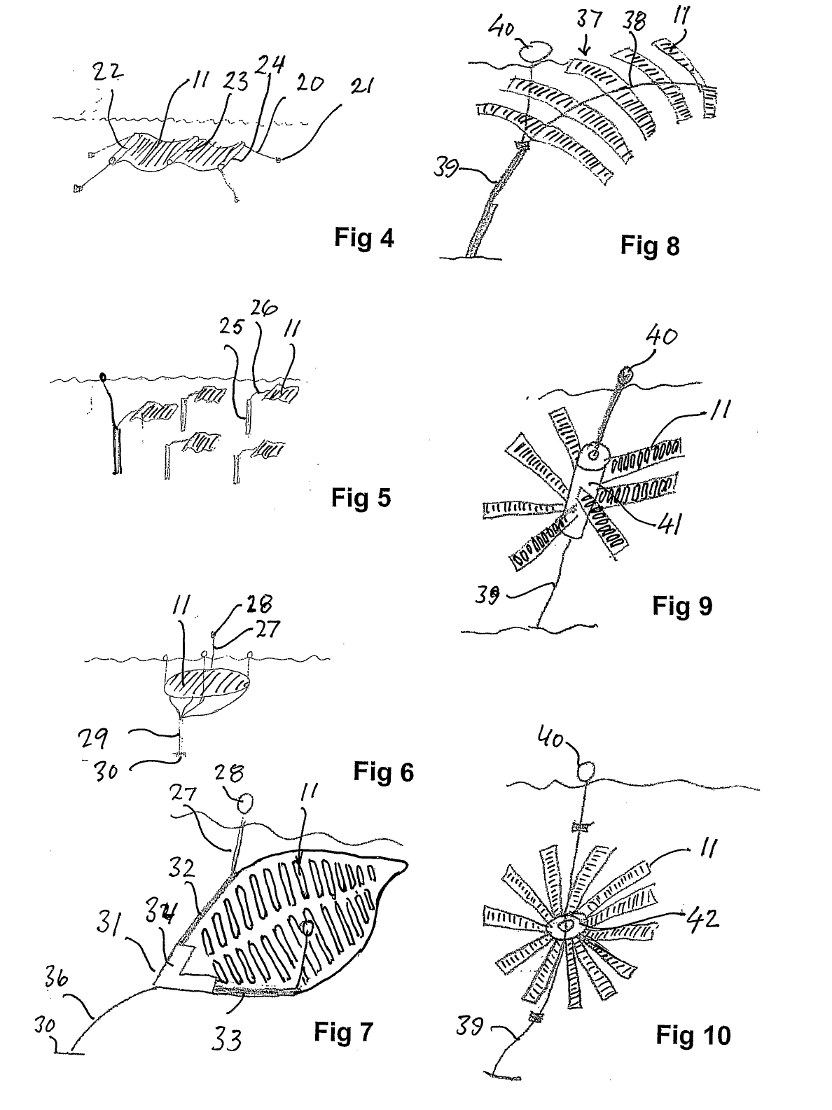

FIG. 4 is showing a perspective view of two rectangular carrier chained together,

FIG. 5 is showing a perspective view of a group of rectangular carrier with single point mooring on poles extending from the sea bottom,

FIG. 6 is showing a perspective view of a circular or ellipsoid carrier with a single point mooring,

FIG. 7 is showing a perspective view of a leaf shaped carrier with single point mooring,

FIGS. 8-10 are showing various group structures of carriers, all being single point moored,

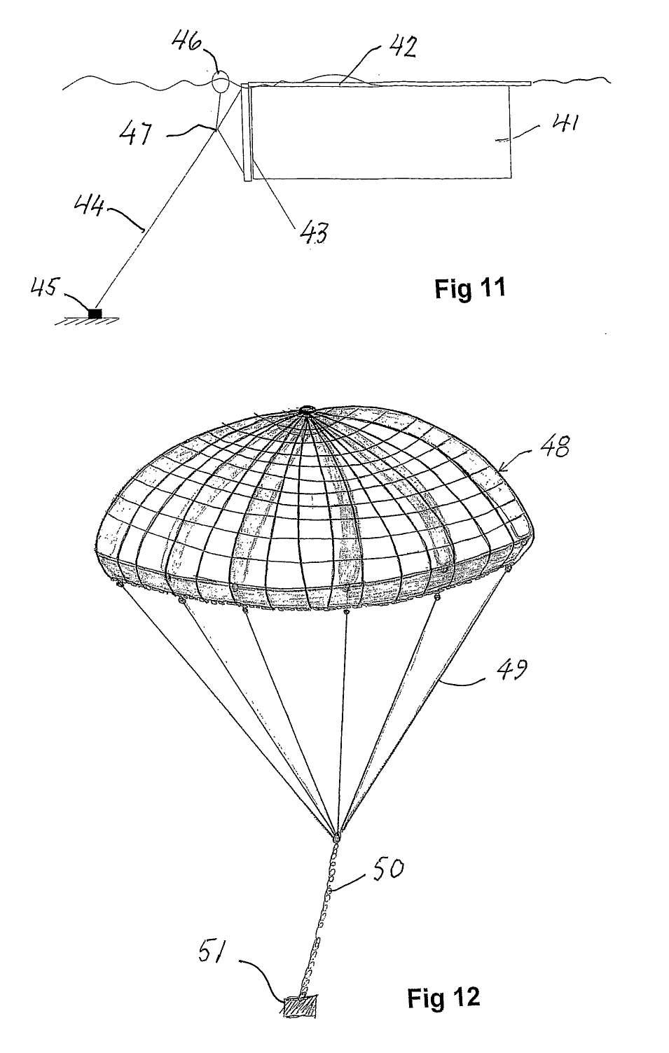

FIG. 11 is showing a side view of a further embodiment of the invention, while

FIG. 12 is showing a perspective view of a still further embodiment of the invention, with a platform for carrying growth carriers or being a growth carrier.

FIG. 1 shows a carrier 11 prepared in the form of a rectangular blanket which is flexible at least longitudinally, i.e. on crosswise extending axis's. The carrier 11 is provided with series of crosswise extending slot 12 leaving intermediate narrow segments 13 of the base material. The carrier 11 can be manufactures of a continuous web, the slots 12 being cut or punched in an integrated or separate process.

On the longitudinal sides of the carrier, a continuous rim 14, 15 is left on both sides. The purpose of the rims 14, 15 is to enable stability and handling of the longitudinal carrier 12 on application of spores, on suspending in a water volume or when harvesting the algae with mechanical means.

The rims 14, 15 of the carrier 11 can be provided with an embedded line or rope 16, 17, partly for reinforcing, partly for suspending, partly for handling.

The ends of the carrier 11 can have an extended solid portion available for attachment means, as illustrated in FIG. 1, for a attachment line as shown in FIG. 3, or for a reinforcement rod.

The carrier can be manufactured by any sheet or web of plastic, textile or combination of such material, which has the property of holding spores or seeds in a growth period in water and which has the mechanical stability and endurance to stand repeated mechanical handling and mechanical harvesting of the growth product.

The carriers may be manufactured of any plastic or organic material or combination of material which is compatible with the object of holding a large number for spores or seeds for growing, and which can endure being suspending continuously in the water.

The carriers can have buoyancy for staying horizontal or for hanging down. They may have a rugged or porous surface, or even be covered by a layer of a different growing substrate, which may have a fertilizer.

The apertures 12 will allow water flow from one side of the carrier to the opposite, reducing the resistance to waves and tidal currents as well as enabling a flow of nutrients in the water to circulate through the carrier.

The seeds or spores can be applied to the carrier by several methods, including spraying with nozzles, immersing in a bath, rolling with a fluid suspension, strewing or even by electrostatical means. The object is to have this process implemented by mechanical means, to reduce the manual efforts and increase the speed.

The applying of the spores may be done on shore, in an inlet (pool), on a vessel or on a platform arranged for serving a macroalgaculture or seaweed farming plant.

FIG. 1 also illustrated the growing of seaweeds 18 on a part of the carrier 11.

This design of the carrier 11 will allow mechanical handling and harvesting of the seaweeds, by exposing the active side or active sides of the carrier which enables more flexibility to move the carrier, e.g. by the use of a suction head, and to remove the seaweed from the carrier.

The rectangular form of the carrier shown in FIG. 1 is only one option. The carrier may have any shape which is suitable for mooring and handling under the given conditions regarding water flow, wave height, and other growth conditions.

The structure of the carrier can also be that of a woven carpet, the basic material be of plastic or grown yarn, or even combination. The requirement is that the material has a general uniform pattern of apertures, like the slots 12 shown or like holes or combinations. The carrier may even be prepared as a sheet like open structure of ropes providing growth areas for seaweed. As an option, a net of sufficient strength may be covered by a perforated layer of a medium suitable for growing seaweed. This medium may even be recycled in a harvesting process.

FIGS. 2 and 3 are showing various embodiments of suspending the carrier according to the invention. In FIG. 2 a series of rectangular carriers 11 are suspended vertically from a line 19. In this example, the lower end of the carriers 11 may have a ballast line. In FIG. 3 a series of carriers 11 are attached at one end or side to a line 19, the buoyancy of the carrier providing a generally horizontal state.

Both embodiments will allow the traffic of mammals without entanglement. In both embodiments, series of parallel lines 18 and 19 may be arranged to cover an area of the sea. FIG. 4 shows two rectangular carriers 11 which are chained together and moored at the resulting four corners with lines 20 from anchors 21 at the sea bottom. At the ends of the carriers 11, flexible tubes 22, 23, 24 are integrated.

FIG. 5 shows a group of five rectangular carrier 11, each being moored to a vertical stem 25, rising from the sea bottom. Each carrier 11 is connected with a line 26, allowing the carriers 11 to adjust horizontally or inclined to the flow of water.

FIG. 6 shows a circular or ellipsoid carrier 11 being suspended in the water with lines 27 from four buoyancy bodies 28 and with a central mooring line 29 connected to an anchor 30 at the sea bottom.

FIG. 7 shows a single carrier 11 with a single point mooring corresponding to the embodiment of FIG. 5. The carrier 11 has lower corner 31 with a pair of flexible rims 32, 33 joined in a corner element 34 attached to the mooring line 35. The corner element 34 may be any suitable reinforcement element attached to the flexible rims 32, 33, which may be of flexible tubes.

The outer end of each flexible rim 32, 33 is connected to a buoyancy element 28 with a line 27.

The shape of the carrier 11 may be like a natural leaf or oblong sheet, suited for suspension in a flowing water volume. The carrier might be reinforced in the middle and from the middle sideward similar to a natural leaf. The line 36 connecting the carrier 11 to the anchor equipment is preferably a flexible rod which will hold the carrier in an oblique position in the water.

Carriers with single point mooring are suitable for offshore/open ocean deployment since the carriers will be pushed down or submerged further by the natural forces of the high waves.

FIGS. 8-10 are showing three different group structures of carriers 11, all having a single point mooring.

FIG. 8 shows a multi foiled leaf 37 with a central flexible stem 38 connected to a stem 39.

FIG. 9 shows a series of ribbon shaped carriers 11 attached to a cylindrical core 41 and pointing in different directions from different heights.

FIG. 10 shows a series of carriers 11 in a daisy structure on a central ring 42.

Common to these embodiments: A buoyancy body 40 is connected to the stems 39, partly to show the site of this group of carriers, partly to keep the stem 39 upright.

Common to all single point mooring embodiments is the arrangement in a sufficient distance to prohibit entanglement of neighboring carriers during storms.

The advantage of this suspension is its unidirectional properties and its insensitiveness for whales. It will also be possible to combine this suspension of the carriers with mechanical handling and harvesting.

FIG. 11 is showing a rectangular carrier 41 with a flexible rod or line 42, e.g. a plastic hose, attached at an upper long side and a rigid bar 43 attached at an adjoining short side. The structure of the carrier 41 and the attached part is chosen to maintain the carrier 41 vertically in the sea. To maintain the carrier 41 on a determined location, a line 44 is extending between a bottom weight 45 and a buoy 46 at the surface. A craw foot 47 is attaching the carrier 41 to the line 44.

FIG. 12 is showing a still further embodiment of the invention. A circular element 48 of a flexible web, e.g. net as shown in the drawing, or a plastic foil or a fabric, which may be closed or having openings, is suspended in the sea, to have the form of a parachute, a mushroom or an umbrella. The circular element 48 may have its own buoyancy or being provided with buoyancy elements. It is even conceivable to provide freshwater inside a close top of a circular element, to provide buoyancy.

To maintain its form and position, the rim of the circular element 48 is tied in by a series of lines 49 connected like the lines of a parachute to a support line 50 extending to a weight 51 suspended in the sea or resting on the seabed. The series of lines 49 may be replaced or reinforced by a conical net (not shown).

The circular element 48 may be used in various ways. It may have the qualities of a carrier for growing seaweed on the element itself. The supply of seeds may even be done with the element suspended in the sea. This may be achieved from a boat with a suitable dispenser for seeds in a fluid.

The circular element 48 as a single structure or as a part of an assembly may be suspended in an adjustable way in the sea, to control the submersion to a suitable depth. For this purpose, the line 50 may be connected to a buoy. This will allow to select the most suitable growth conditions for each part of the growth period and for each particular environment.

The harvesting may be done from a boat, with equipment acting direct on the circular element 48. In an alternative embodiment, the circular element 48 may act as a platform for suspending a carrier according to the invention. Then a carrier being provided with seeds may be disposed on the platform. After the growth period, this carrier with seaweed may be harvested.

Generally, there are three ways of providing seeds or spores to the carriers:
by spraying or other application onshore
by spraying offshore, i.e. in the sea
by natural spore attachment

What is claimed is:

1. Carrier for growing macroalgae, with an element provided for the growth of seeds deposited thereon, and having elements for suspension in a water volume, characterized in that the carrier (11) is a sheet provided with apertures (12) allowing the flow of water from one side to the other, the surface of the sheet having a structure which will retain spores and seeds.

2. Carrier (11) according to claim 1, characterized in that the apertures are generally parallel slots (12).

3. Carrier according to claim 1, characterized in that the apertures are series of generally circular openings.

4. Carrier according to claim 1, characterized in that the carrier is rectangular, leaf shaped or oblong, with a rim (14, 15) on at least on side for suspending.

5. Carrier according to claim 4, characterized in that the rim (14, 15) has an embedded line (16, 17) for reinforcement and suspension.

6. Carrier according to claim 1, characterized in that it comprises a laminated structure with a relatively strong and thin foil material and a layer of growth substance, which may be biodegradable.

7. Carrier according to claim 1, characterized in that the sheet includes a net of reinforcement lines.

8. Carrier according to claim 1, characterized in that it comprises a fertilizer and/or nutrient substance for enhancing the growth of the macroalgae.

9. Carrier according to claim 1, characterized in that the buoyancy is varying along the length of en extended carrier, to achieve an undulated shape when suspended in the water.

10. Arrangement for suspending a carrier (11) according to claim 1, characterized in that it comprises connecting means (16, 17; 32, 33) connected to at least one part of an edge (14; 31) of the carrier.

11. Arrangement according to claim 10, characterized in that the connecting means (32, 33) connected to the edge of the carrier (11, FIG. 7) is connected to a single attachment means (36).

12. Arrangement according to claim 11, characterized in that the attachment means (36) is anchored at the sea bottom and that it comprises at least one buoyancy element (28).

13. Carrier according to claim 1, particularly with a rectangular form, characterized in that a flexible rod (42) with buoyancy is attached or integrated at one side, and a more rigid rod (43) is attached at an adjoining side, said more rigid rod being provided for suspension of the carrier (41) in a generally vertical position, with the freedom to follow the flow of the sea.

14. Arrangement for suspending a carrier according to claim 1, characterized in that it comprises a generally circular element (48) with buoyancy and with lines or a net or a foil or fabric connecting the edge in a parachute manner, said lines and/or net being connected to a weight (51).

15. Arrangement according to claim 14, characterized in that the circular element (48) is a carrier for growth of macroalgae or a platform for carrying such a carrier.
